(19) United States
(12) Patent Application Publication
(10) Pub. No.: US 2025/0292317 A1
(43) Pub. Date: Sep. 18, 2025

(54) EMPLOYER-EMPLOYEE BONUS SAVINGS PLAN WITH ATTACHED SAVINGS ACCOUNT AND DEBIT CARD-APP

(71) Applicant: Gaymian Paul James, Brown Mills, NJ (US)

(72) Inventor: Gaymian Paul James, Brown Mills, NJ (US)

(21) Appl. No.: 18/964,314

(22) Filed: Nov. 29, 2024

Related U.S. Application Data
(60) Provisional application No. 63/603,941, filed on Nov. 29, 2023.

(51) Int. Cl. G06Q 40/02; G06Q 40/12

(52) U.S. Cl. CPC G06Q 40/02; G06Q 40/12

(57) ABSTRACT

An employer-employee bonus savings plan system may comprise a bonus calculation module, a savings account module, a debit card module, and a mobile application module. The bonus calculation module may determine bonus amounts for employees based on a percentage of each employee's yearly base pay. The savings account module may manage individual savings accounts for each employee participating in the bonus plan. The debit card module may manage debit cards linked to the individual savings accounts. The mobile application module may enable employees to access and manage their bonus savings accounts via a mobile device. The system may interface with a company payroll system to obtain employee salary information. The savings account module may handle account creation, fund deposits, interest accrual, and fund transfers. The debit card module may handle card issuance, transaction processing, and fraud detection. The mobile application module may provide features including balance checking, fund transfers, and transaction history viewing.

### CROSS-REFERENCE TO RELATED APPLICATIONS

This application claims the benefit of U.S. Provisional Patent Application No. 63/603,941, filed on Nov. 29, 2023, the entire contents of which are hereby incorporated by reference.

### FIELD OF THE INVENTION

The present disclosure generally relates to employee compensation systems. More particularly, the present disclosure relates to an employer-employee bonus savings plan with an attached savings account, debit card, and mobile application.

### BACKGROUND

Conventional employee bonus systems often result in disproportionate distributions of bonuses, with upper management and executives typically receiving significantly larger bonuses compared to lower-level employees. This disparity may lead to issues of perceived inequity within organizations and may not effectively incentivize all levels of employees. The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF SUMMARY

In one aspect, the present disclosure provides an employer-employee bonus savings plan system. The system may include a bonus calculation module configured to determine bonus amounts for employees based on a percentage of each employee's yearly base pay. The system may also include a savings account module configured to manage individual savings accounts for each employee participating in the bonus plan. A debit card module may be included to manage debit cards linked to the individual savings accounts. Additionally, a mobile application module may be provided to enable employees to access and manage their bonus savings accounts via a mobile device.

In another aspect, the present disclosure provides a method for implementing an employer-employee bonus savings plan. The method may include calculating bonus amounts for eligible employees based on a predetermined percentage of each employee's yearly base pay, distributing the calculated bonus amounts to individual savings accounts associated with each eligible employee, providing debit cards linked to the individual savings accounts, and enabling access to the individual savings accounts through a mobile application.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The accompanying drawings, which are incorporated in and constitute a part of this specification, illustrate embodiments of the disclosure and, together with a general description of the disclosure given above, and the detailed description given below, serve to explain the principles of the disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure.

The accompanying drawings, which are incorporated in and constitute a part of this specification, illustrate one or more embodiments of the invention and, together with the description, explain the invention. The present disclosure will become more fully understood from the detailed description and the accompanying drawings, wherein:

FIG. 1 is a schematic diagram illustrating an example employer-employee bonus savings plan system according to various embodiments of the present disclosure;

FIG. 2 is a flowchart illustrating an example method for implementing an employer-employee bonus savings plan according to various embodiments of the present disclosure;

FIG. 3 is a block diagram illustrating example components of a bonus calculation module according to various embodiments of the present disclosure;

FIG. 4 is a block diagram illustrating example components of a savings account module according to various embodiments of the present disclosure;

FIG. 5 is a block diagram illustrating example components of a debit card module according to various embodiments of the present disclosure; and

FIG. 6 is a block diagram illustrating example components of a mobile application module according to various embodiments of the present disclosure.

FIG. 7 is a system diagram according to an embodiment of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The invention will be described in detail with reference to certain preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Throughout this specification and the claims, the terms “comprise,” “comprising,” “include,” “including,” and the like are to be understood to imply the inclusion of stated elements but not the exclusion of any other elements. The term “exemplary” is used in the sense of “example” rather than “ideal” or “model.” As used herein, the terms “about” or “approximately” apply to all numeric values, whether or not explicitly indicated. These terms generally refer to a range of numbers that one of skill in the art would consider equivalent to the recited values (i.e., having the same function or result).

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following description of various embodiments is merely exemplary in nature and is in no way intended to limit the disclosure, its application, or uses.

The following description is merely illustrative in nature and is in no way intended to limit the disclosure, its application, or uses. For purposes of clarity, the same reference numbers will be used in the drawings to identify similar elements. As used herein, the phrase “at least one of” A, B, and C should be construed to mean a logical (A or B or C), using a non-exclusive logical OR. It should be understood that steps within a method may be executed in different order without altering the principles of the present disclosure. As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

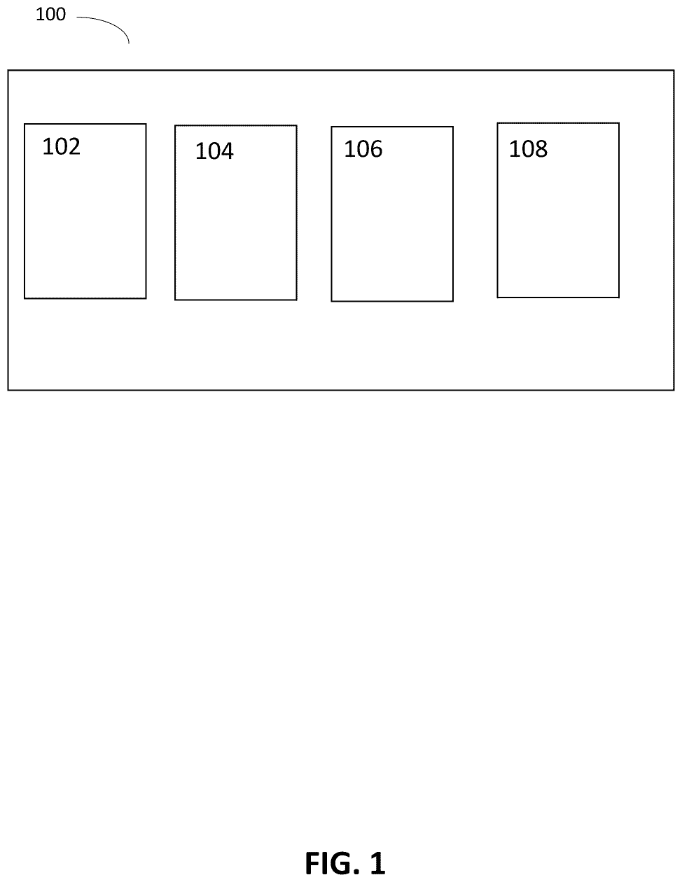

Referring now to FIG. 1, a schematic diagram illustrating an example employer-employee bonus savings plan system 100 is shown. The system 100 may include a bonus calculation module 102, a savings account module 104, a debit card module 106, and a mobile application module 108. These modules may be implemented as hardware, software, or a combination thereof. The bonus calculation module 102 may be configured to determine bonus amounts for employees based on a percentage of each employee's yearly base pay. The percentage may be set by the employer or based on market rates. The bonus calculation module 102 may interface with the company's payroll system to obtain employee salary information. The savings account module 104 may be configured to manage individual savings accounts for each employee participating in the bonus plan. This module may handle tasks such as account creation, fund deposits, interest accrual, and fund transfers. The debit card module 106 may be configured to manage debit cards linked to the individual savings accounts. This may include tasks such as card issuance, transaction processing, and fraud detection. The mobile application module 108 may be configured to enable employees to access and manage their bonus savings accounts via a mobile device. This may include features such as balance checking, fund transfers, and transaction history viewing.

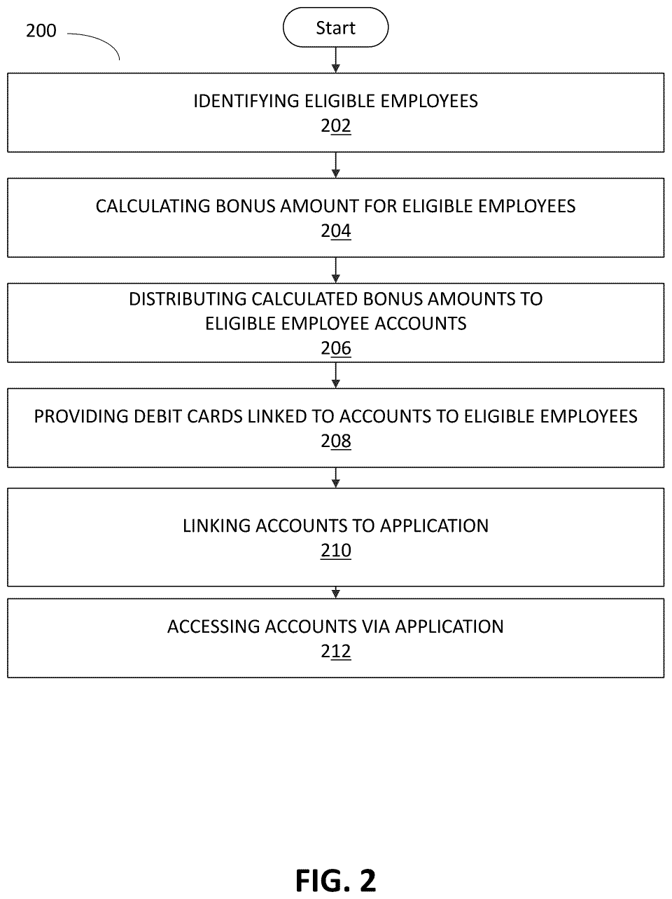

Referring now to FIG. 2, a flowchart illustrating an example method 200 for implementing an employer-employee bonus savings plan is shown. The method 200 may begin at step 202, where eligible employees are identified. Eligibility may be based on factors such as length of employment. At step 204, bonus amounts may be calculated for eligible employees based on a predetermined percentage of each employee's yearly base pay. The percentage may be set by the employer or based on market rates. At step 206, the calculated bonus amounts may be distributed to individual savings accounts associated with each eligible employee. This distribution may occur annually or at another predetermined interval. At step 208, debit cards linked to the individual savings accounts may be provided to the employees. These debit cards may allow employees to access their bonus funds at ATMs worldwide or make purchases directly from their bonus savings accounts. At step 210, access to individual savings accounts are linked to an application. In one or more instances, the application may be a software application, mobile application, web application, website and the like. At step 212, access to the individual savings accounts may be enabled through a mobile application. This application may allow employees to check their account balances, transfer funds, and view transaction histories.

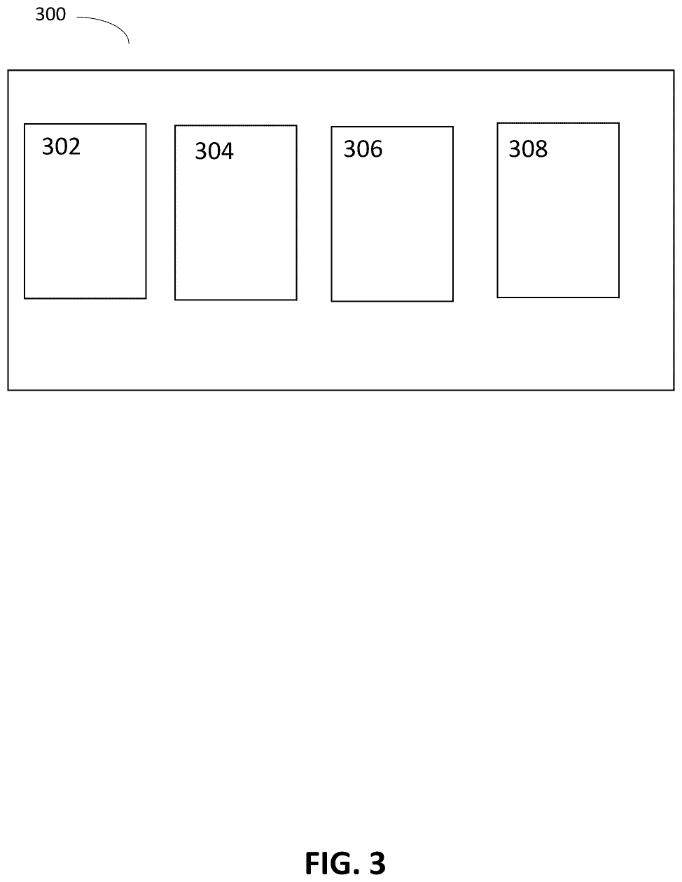

FIG. 3 is a block diagram illustrating example components of a bonus calculation module 300 according to various embodiments of the present disclosure. The bonus calculation module 300 may include a salary data retrieval component 302, a percentage determination component 304, a calculation engine 306, and a distribution initiation component 308. The salary data retrieval component 302 may be configured to interface with a company's payroll system to obtain employee salary information. This component may securely access and extract relevant salary data for each eligible employee. The percentage determination component 304 may be configured to determine the appropriate bonus percentage to be applied to each employee's salary. This component may consider factors such as company-set rates, market rates, or other predetermined criteria to establish the bonus percentage. The calculation engine 306 may be configured to perform the actual bonus amount calculations based on the salary data and determined percentages. This component may apply the appropriate percentage to each employee's yearly base pay to determine their individual bonus amount. The distribution initiation component 308 may be configured to initiate the process of distributing the calculated bonus amounts to the individual employee savings accounts. This component may generate instructions for fund transfers to be executed by the savings account module.

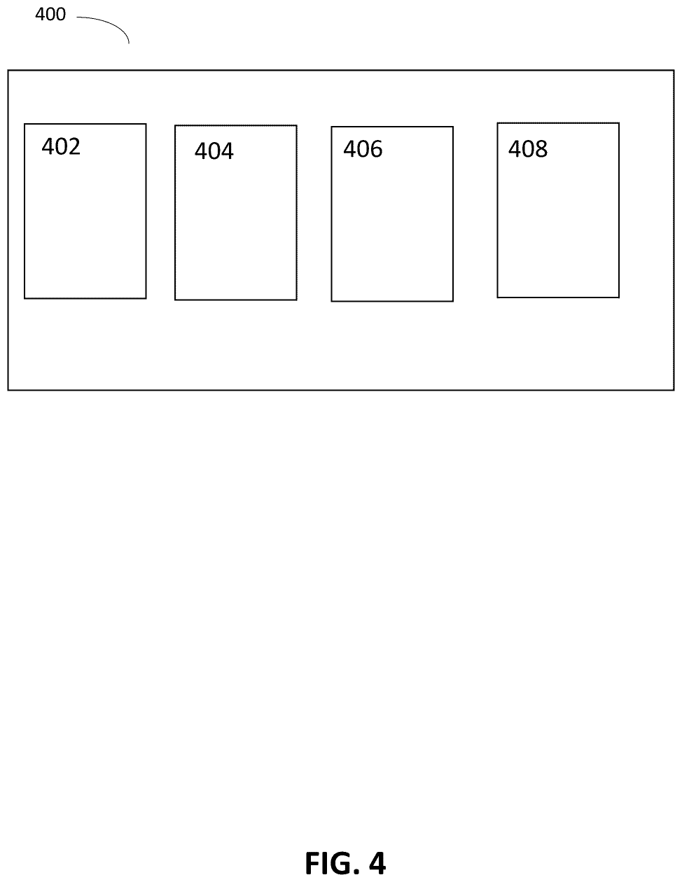

FIG. 4 is a block diagram illustrating example components of a savings account module 400 according to various embodiments of the present disclosure. The savings account module 400 may include an account creation component 402, a fund management component 404, an interest calculation component 406, and a reporting component 408. The account creation component 402 may be configured to set up new savings accounts for employees participating in the bonus plan. This component may handle tasks such as generating account numbers and establishing initial account parameters. The fund management component 404 may be configured to handle deposits, withdrawals, and transfers related to the bonus savings accounts. This component may process incoming bonus deposits and manage outgoing transfers initiated by employees. The interest calculation component 406 may be configured to calculate and apply interest to the funds in the savings accounts. This component may determine appropriate interest rates based on state regulations or market conditions and apply them to account balances. The reporting component 408 may be configured to generate periodic statements and reports for both employees and employers regarding account activity and balances.

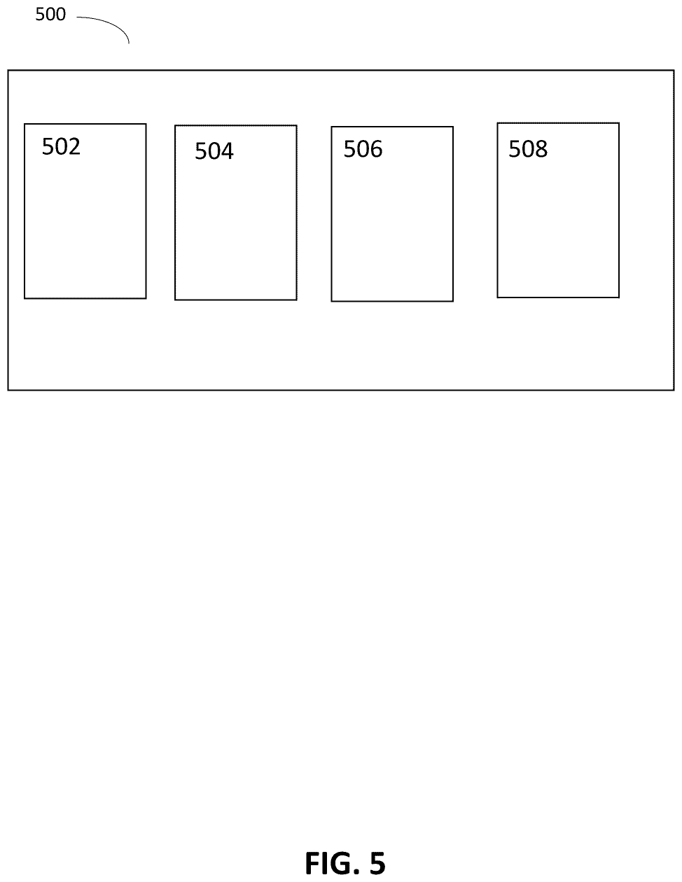

FIG. 5 is a block diagram illustrating example components of a debit card module 500 according to various embodiments of the present disclosure. The debit card module 500 may include a card issuance component 502, a transaction processing component 504, a fraud detection component 506, and a card management component 508. The card issuance component 502 may be configured to handle the production and distribution of physical debit cards linked to employees' bonus savings accounts. This component may manage the card personalization process and coordinate card delivery to employees. The transaction processing component 504 may be configured to handle authorizations and settlements for transactions made using the bonus debit cards. This component may interface with payment networks to process purchases and ATM withdrawals. The fraud detection component 506 may be configured to monitor card activity for potential fraudulent transactions. This component may employ various algorithms and rules to identify suspicious patterns and trigger appropriate security measures. The card management component 508 may be configured to handle various card-related tasks such as PIN changes, card replacements, and temporary freezes. This component may provide an interface for employees to manage their debit card settings and preferences.

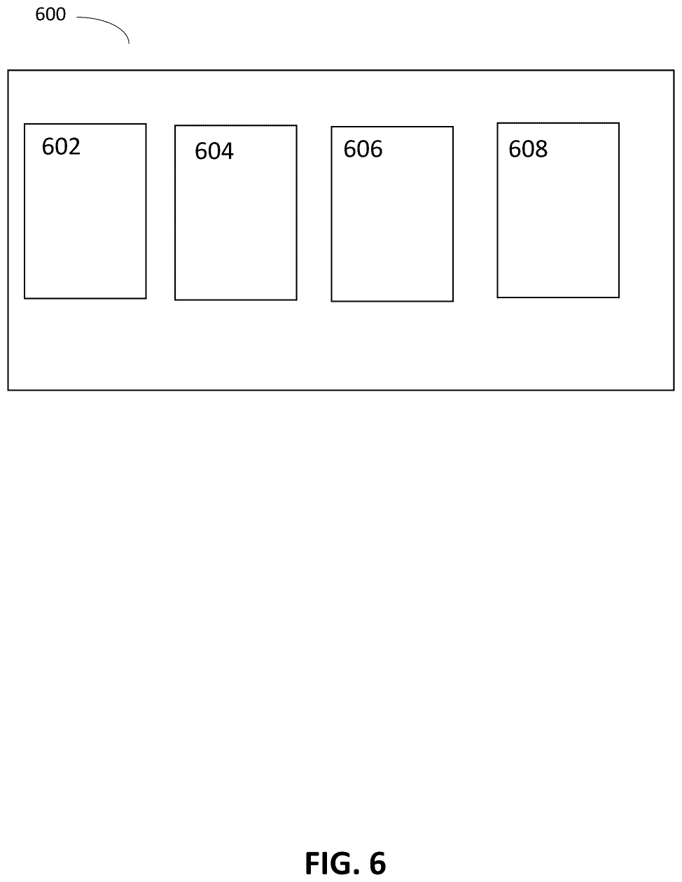

FIG. 6 is a block diagram illustrating example components of a mobile application module 600 according to various embodiments of the present disclosure. The mobile application module 600 may include a user authentication component 602, an account information component 604, a transaction component 606, and a notification component 608. The user authentication component 602 may be configured to verify the identity of users accessing the mobile application. This component may implement various security measures such as biometric authentication or multi-factor authentication to ensure secure access to account information. The account information component 604 may be configured to retrieve and display current account balances, transaction histories, and other relevant account details. This component may provide users with a comprehensive view of their bonus savings account status. The transaction component 606 may be configured to enable users to initiate various transactions such as transfers between accounts or bill payments using their bonus funds. This component may interface with the savings account module to process these transactions. The notification component 608 may be configured to generate and deliver push notifications, alerts, and reminders to users regarding their bonus savings accounts. This component may notify users of important events such as bonus deposits, large transactions, or approaching savings goals.

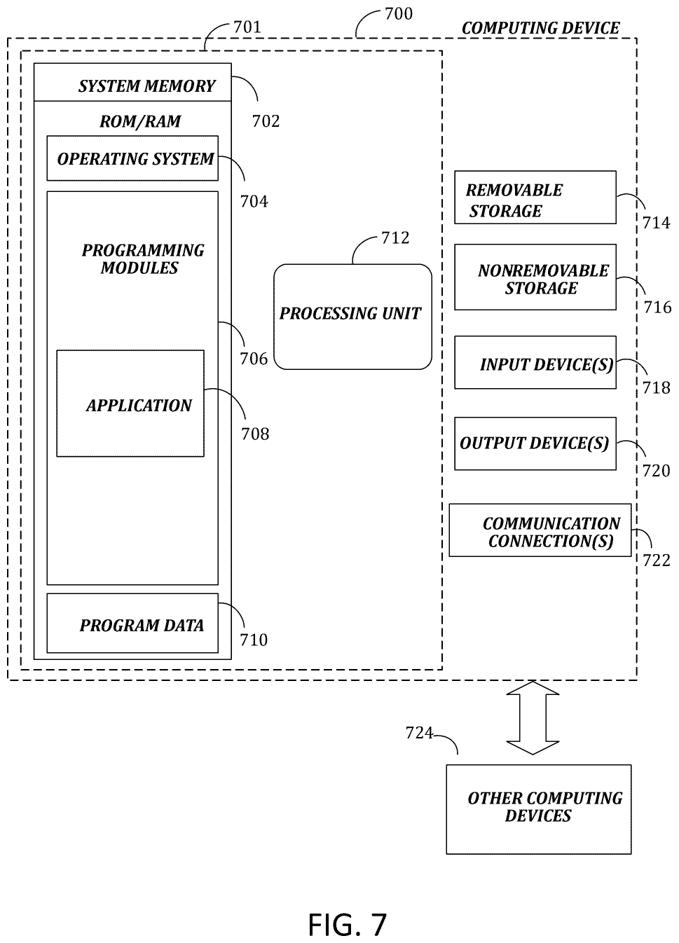

Referring now to FIG. 7, is a block diagram of a system including computing device 700. Consistent with an embodiment of the disclosure, the aforementioned memory storage and processing unit may be implemented in a computing device, such as computing device 700 of FIG. 7. Any suitable combination of hardware, software, or firmware may be used to implement the memory storage and processing unit. For example, the memory storage and processing unit may be implemented with computing device 700 or any of other computing devices 718, in combination with computing device 700. The aforementioned system, device, and processors are examples and other systems, devices, and processors may comprise the aforementioned memory storage and processing unit, consistent with embodiments of the disclosure.

With reference to FIG. 7, a system consistent with an embodiment of the disclosure may include a computing device, such as computing device 700. In a basic configuration, computing device 700 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 406, and may include a program data 707. Operating system 705, for example, may be suitable for controlling computing device 700's operation. In one embodiment, programming modules 406 may include application 720. Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702, programming modules 706 (application 720) may perform processes including, for example, one or more of method 200's stages as described above. The aforementioned process is an example, and processing unit 702 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and quantum computing elements. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The system and method described above may provide several advantages over conventional bonus systems. By distributing bonuses as a percentage of base pay, the system may promote a more equitable distribution of bonuses across all levels of employees. The attached savings account, debit card, and mobile application may provide employees with easy access to and management of their bonus funds. The system may also include a reporting module configured to generate periodic reports on bonus distributions and account activity. These reports may be useful for both employees and employers to track bonus trends and savings behaviors over time.

The savings account module may be further configured to offer different account types, such as high-yield savings accounts or money market accounts, allowing employees to choose the best option for their financial goals. This flexibility may encourage employees to leave their bonus funds in the account for longer periods, potentially increasing their overall savings. The debit card module may incorporate advanced security features, such as real-time transaction alerts and the ability to temporarily freeze the card through the mobile application. These features may help protect employees' bonus funds from unauthorized access or fraudulent activity. The mobile application module may include educational resources about financial planning and investment strategies. This feature could help employees make informed decisions about how to best utilize their bonus funds, potentially improving their overall financial well-being. The bonus calculation module may be designed to accommodate different bonus structures for various employee levels or departments while still maintaining overall fairness. For example, it may allow for slight variations in the percentage of base pay used for bonus calculations based on factors such as job responsibilities or company tenure.

The system may also include an integration module that allows for seamless connection with other company systems, such as human resources management software or payroll systems. This integration may streamline the bonus distribution process and reduce the potential for errors in data transfer between systems. The mobile application module may offer budgeting tools that help employees plan how to use their bonus funds effectively. These tools could include features such as goal setting, expense tracking, and savings projections based on different scenarios. The system may incorporate a feedback mechanism that allows employees to provide input on the bonus savings plan. This feature could help companies refine and improve the plan over time based on employee needs and preferences. The debit card module may support virtual card functionality, allowing employees to access their bonus funds through digital wallets on their smartphones. This feature may provide additional convenience and security for employees who prefer contactless payment methods. The savings account module may include an automatic savings feature that allows employees to set up recurring transfers from their regular paycheck to their bonus savings account. This feature could help employees supplement their annual bonus with additional savings throughout the year.

The system may also include a notification module that sends alerts to employees about important account activities or milestones. For example, the notification module may send a message when the annual bonus has been deposited, when the account balance reaches a certain threshold, or when a large purchase is made using the debit card. These notifications may be sent via email, text message, or push notifications through the mobile application. The bonus calculation module may be further configured to adjust bonus percentages based on company performance metrics. This feature may allow companies to tie bonus amounts more closely to overall business success, potentially increasing employee engagement and motivation. The module may use predefined formulas that take into account factors such as revenue growth, profit margins, or customer satisfaction scores. The savings account module may offer a tiered interest rate structure, where higher account balances earn higher interest rates. This feature may encourage employees to keep their bonus funds in the account for longer periods, potentially increasing their overall savings. The tiered structure may be automatically applied based on the account balance, with no action required from the employee.

The debit card module may incorporate a rewards program, allowing employees to earn points or cashback on purchases made with their bonus debit card. These rewards may be redeemable for travel, merchandise, or additional deposits into the bonus savings account. The rewards program may be designed to encourage responsible spending and saving habits among employees. The mobile application module may include a goal-setting feature that allows employees to create and track financial goals related to their bonus funds. This feature may help employees visualize their progress towards specific objectives, such as saving for a down payment on a house or funding a child's education. The application may provide visual representations of goal progress and offer suggestions for reaching goals more quickly.

The system may incorporate a financial education component that provides employees with resources and tools to improve their financial literacy. This may include articles, videos, or interactive modules covering topics such as budgeting, investing, and retirement planning. The educational content may be tailored to different employee demographics and experience levels, ensuring relevance for all users of the system. The financial education component may include a financial literacy assessment tool. This tool may evaluate an employee's current level of financial knowledge through a series of questions and interactive exercises. Based on the assessment results, the system may generate personalized recommendations for educational content and resources tailored to the employee's specific needs and knowledge gaps.

The system may offer a goal-setting feature within the mobile application. This feature may allow employees to set specific financial goals, such as saving for a down payment on a house or building an emergency fund. The goal-setting tool may provide suggested milestones and timelines based on the employee's current savings rate and bonus amount. The system may track progress towards these goals and provide regular updates and encouragement to the employee.

A budgeting tool may be integrated into the mobile application. This tool may analyze the employee's spending patterns by categorizing transactions made with the linked debit card. The budgeting tool may provide visual representations of spending habits, such as pie charts or graphs, to help employees better understand their financial behaviors. The tool may also offer suggestions for potential areas of cost-saving based on the employee's unique spending profile.

The system may incorporate a virtual financial advisor feature. This feature may use artificial intelligence algorithms to analyze an employee's financial situation, including their bonus savings, regular income, expenses, and financial goals. Based on this analysis, the virtual advisor may provide personalized recommendations for saving, investing, or using the bonus funds. The advisor may also alert employees to potential financial opportunities or risks based on their individual circumstances.

A rewards program may be implemented in conjunction with the debit card module. This program may offer cashback or points for certain types of purchases made with the debit card linked to the bonus savings account. The rewards may be structured to encourage responsible financial behaviors, such as offering higher rewards for purchases related to education or essential household items. Accumulated rewards may be deposited directly into the employee's bonus savings account, further increasing their savings.

The system may feature an investment option module. This module may allow employees to allocate a portion of their bonus savings into various investment vehicles, such as mutual funds or exchange-traded funds. The investment options may be curated to offer a range of risk profiles, allowing employees to choose investments that align with their financial goals and risk tolerance. The module may provide educational resources about each investment option to help employees make informed decisions.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims. While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112 (f), unless the element is expressly recited using the exact phrase “means for . . . ” and no method or process step herein is to be construed under the provisions of 35 U.S.C. section 112 (f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure. While specific embodiments of the invention have been described and illustrated, such embodiments should be considered illustrative of the invention only and not as limiting the invention as construed in accordance with the accompanying claims.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. It is to be understood that the foregoing description is not intended to limit the scope of the present disclosure. The present disclosure contemplates numerous variations, modifications, and adaptations that will become apparent to those skilled in the art upon reading and understanding the foregoing description. The scope of the present disclosure is defined by the appended claims and their legal equivalents.

What is claimed is:

1. A system for implementing an employer-employee bonus savings plan, the system comprising:
a bonus calculation module configured to determine bonus amounts for employees based on a percentage of each employee's yearly base pay;
a savings account module configured to manage individual savings accounts for each employee participating in the bonus plan;
a debit card module configured to manage debit cards linked to the individual savings accounts; and
a mobile application module configured to enable employees to access and manage their bonus savings accounts via a mobile device.

2. The system of claim 1, wherein the bonus calculation module is further configured to interface with a company payroll system to obtain employee salary information.

3. The system of claim 1, wherein the savings account module is further configured to handle account creation, fund deposits, interest accrual, and fund transfers.

4. The system of claim 1, wherein the debit card module is further configured to handle card issuance, transaction processing, and fraud detection.

5. The system of claim 1, wherein the mobile application module is further configured to provide features comprising balance checking, fund transfers, and transaction history viewing.

6. A method for implementing an employer-employee bonus savings plan, the method comprising:
identifying eligible employees;
calculating bonus amounts for the eligible employees based on a predetermined percentage of each employee's yearly base pay;
distributing the calculated bonus amounts to individual savings accounts associated with each eligible employee;
providing debit cards linked to the individual savings accounts; and
enabling access to the individual savings accounts through a mobile application.

7. The method of claim 6, wherein identifying eligible employees comprises determining which employees have been employed for at least one year.

8. The method of claim 6, wherein the predetermined percentage is set by an employer or based on market rates.

9. The method of claim 6, wherein distributing the calculated bonus amounts occurs annually.

10. The method of claim 6, wherein the debit cards allow employees to access their bonus funds at ATMs worldwide or make purchases directly from their bonus savings accounts.

11. The method of claim 6, wherein the mobile application allows employees to check their account balances, transfer funds, and view transaction histories.

12. A non-transitory computer-readable medium storing instructions that, when executed by a processor, cause the processor to perform operations comprising:
calculating bonus amounts for eligible employees based on a predetermined percentage of each employee's yearly base pay;
initiating distribution of the calculated bonus amounts to individual savings accounts associated with each eligible employee;
managing debit cards linked to the individual savings accounts; and
providing access to the individual savings accounts through a mobile application.

13. The non-transitory computer-readable medium of claim 12, wherein the operations further comprise interfacing with a company payroll system to obtain employee salary information.

14. The non-transitory computer-readable medium of claim 12, wherein managing the individual savings accounts comprises handling account creation, fund deposits, interest accrual, and fund transfers.

15. The non-transitory computer-readable medium of claim 12, wherein managing the debit cards comprises handling card issuance, transaction processing, and fraud detection.

16. The non-transitory computer-readable medium of claim 12, wherein providing access through the mobile application comprises enabling balance checking, fund transfers, and transaction history viewing.

17. The system of claim 1, wherein the bonus calculation module is further configured to calculate bonus amounts for all employees of a company, from lower-level employees to executives.

18. The system of claim 1, wherein the savings account module is further configured to apply interest to saved bonus funds based on state-allowed rates or market rates.

19. The method of claim 6, further comprising allowing employees to save their bonuses for large purchases or as an emergency fund.

20. The non-transitory computer-readable medium of claim 12, wherein the operations further comprise controlling bonus payouts to all employees and executives to allow a company to save money and control their bottom line.
